(19) United States
(12) Patent Application Publication
(10) Pub. No.: US 2020/0368595 A1
(43) Pub. Date: Nov. 26, 2020

(54) IMPROVED BAT

(71) Applicant: Pure Sports Technologies, LLC, Charleston, SC (US)

(72) Inventor: Christopher Osborne, Charleston, SC (US)

(73) Assignee: Pure Sports Technologies, LLC, Charleston, SC (US)

(21) Appl. No.: 16/880,013

(22) Filed: May 21, 2020

Related U.S. Application Data
(60) Provisional application No. 62/850,653, filed on May 21, 2019.

(51) Int. Cl. A63B 59/51; A63B 59/54; B32B 15/20

(52) U.S. Cl. CPC A63B 59/51; A63B 59/58; B32B 15/20; A63B 59/54

(57) ABSTRACT

A bat includes a handle configured to be held by a user having a first end and a second end opposite the first end, the first end includes a knob having a larger diameter than the handle. The bat further includes a barrel extending from the second end of a handle, the barrel configured to strike a ball during play. The barrel includes a first layer primarily composed of a single wall aluminum, a double wall aluminum, a single wall titanium, a double wall titanium, a single wall composite, or a multi wall composite. A second layer is connected to the first layer and configured to support the first layer to prevent the first layer from fatiguing, permanent damage, or exceeding applicable rules limiting the hotness of the bat.

### CROSS-REFERENCE TO REPLATED APPLICATION

This application claims priority to U.S. Provisional Patent Application No. 62/850,653, filed on May 21, 2019, the entire contents of such application being incorporated by reference herein.

### BACKGROUND

Baseball and softball are very competitive sports, and the athletes who compete in these sports are always looking for an edge. Initially, bats were formed from wood. While wooden bats generally produce consistent results (as far as distance of travel of a ball), bats formed from other materials, like metals and composites, allow players to hit the ball farther than with wooden bats. Over time, non-wooden bats have been optimized to make them “hotter”, meaning the bats hit the ball farther, than wooden bats as well as earlier versions of the non-wooden bats. Initially this was done by changing the materials used from metal, like a steel, to a lighter metal, like aluminum, a hard and light metal, like titanium, or even manufacturing bats from composites.

The non-wooden bats were made even hotter by reducing the wall thickness of the barrel of the bat so that the bats produced a trampoline or spring-like effect causing the ball to go even farther, fly off the bat even faster, etc. Once the walls of the bat became very thin, playing with these bats became more dangerous because they were too “hot”. Additionally, these thin walled bats would fatigue over time through repeated use, which made them even hotter and also made them eventually break, crack or otherwise wear out. For instance, composite bats begin getting microcracks, or small fractures, that spread, which initially causes a hotter bat, but eventually causes the bat to fail. Traditional paints and labels do not prevent this from happening.

To address the “hotness” issue, there are rules in softball and baseball leagues that limit the hotness of the bats. For example, the Amateur Softball Association looks at batted ball speed, collision efficiency, and bat-ball coefficient of restitution to determine whether a bat is too hot to be allowed. Manufacturers of bats want their bats to be as hot as possible, without being illegal. However, some of the newer bats pass hotness guidelines when sold, but they fatigue over time and after repeated use to the point at which they become too hot or otherwise exceed the maximum hotness regulations for the league. What is needed is a way to ensure that a bat does not fatigue to a point of being no longer compliant with the applicable hotness rules as a result of being used.

### SUMMARY

According to an implementation described herein, a bat includes a handle configured to be held by a user, the handle having a first end and a second end opposite the first end, the first end including a knob having a larger diameter than the handle. A barrel extends from the second end of a handle and is configured to strike a ball during play. The barrel includes a first layer primarily composed of a single wall aluminum, a double wall aluminum, a single wall titanium, a double wall titanium bat, a single wall composite or a multi wall composite. A second layer is connected to the first layer and configured to support the first layer to prevent the first layer from fatiguing, permanent damage, or exceeding applicable rules limiting the hotness of the bat. The bat may include a gap between the first layer and the second layer. The second layer may include an elastomeric polyurea. Second layer may include a thermoplastic. First layer may be outside of second layer. First layer may be inside second layer. First layer may include paint. The gap may be located at or near the sweet spot. The second layer may include an aperture. The second layer may have a uniform thickness. The second layer may have a non-uniform thickness. The second layer may be formed from a clear material. A cap may be connected to the barrel opposite the handle, the cap providing a closed end of the barrel. The first layer may be connected to the second layer at connection points.

According to another implementation described herein, a bat includes a handle configured to be held by a user, the handle having a first end and a second end opposite the first end, the first end including a knob having a larger diameter than the handle. The bat may further include a barrel extending from the second end of a handle, the barrel configured to strike a ball during play, the barrel having a first layer corresponding to the barrel of a conventional bat that is configured to provide a trampoline effect. A second layer connected to the first layer and configured to support the first layer to prevent the first layer from fatiguing, permanent damage, or exceeding applicable rules limiting the hotness of the bat. The second layer may include an elastomeric polyurea and/or a thermoplastic. The first layer may be formed from composite, aluminum and/or another material. The first layer may be a double wall aluminum. The first layer may include paint.

### BRIEF DESCRIPTION OF THE DRAWINGS

FIGS. 1A and 1B illustrate a non-limiting example embodiment of a bat that may be used in connection with the technologies and/or techniques described herein.

FIG. 2 illustrates an alternative non-limiting example embodiment of a bat that may be used in connection with the technologies and/or techniques described herein.

FIG. 3 illustrates yet another alternative non-limiting example embodiment of a bat that may be used in connection with the technologies and/or techniques described herein.

### DETAILED DESCRIPTION

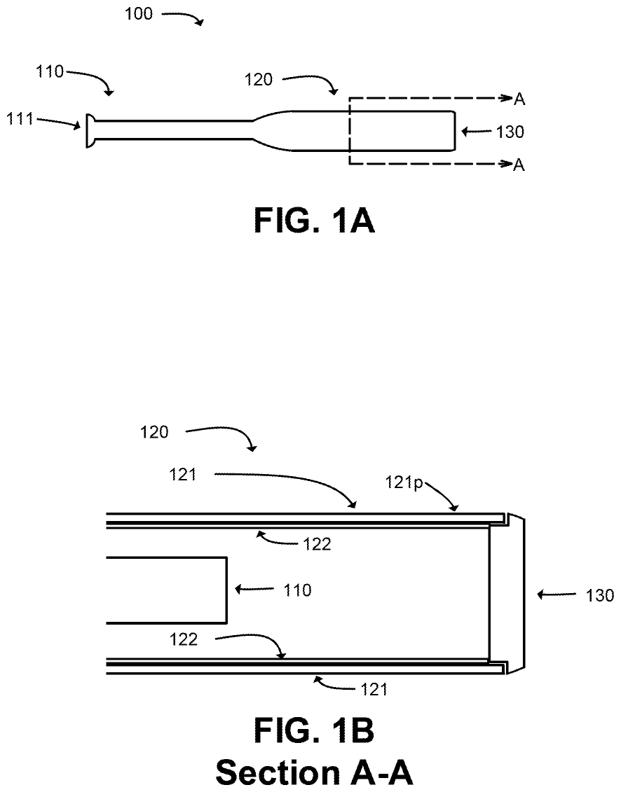

FIGS. 1A-3 are attached hereto and incorporated herein by reference. The following detailed description refers to the accompanying FIGS. 1A-3. The same reference numbers in different figures may identify the same or similar elements.

The technologies and/or techniques described herein may provide a bat that may be used repeatedly without fatiguing, which may prevent the bat from breaking (e.g. cracking, deforming, etc.) and/or prevent the bat from exceeding certain “hotness limitations” imposed by applicable league authorities. Additionally, or alternatively, the technologies and/or techniques may allow manufacturers to manufacture bats that have the maximum allowed hotness, but that do not ever exceed the maximum hotness requirements, regardless of how many times the bat is used. Unlike traditional bats, the technologies and/or techniques described herein provide for a bat that has a two-layer barrel, with the first layer barrel being the material that strikes the ball, and the second layer supporting the first layer, and preventing it from fatiguing and/or from becoming hotter when used. While the second layer is depicted as being within the barrel, the second layer may be within the barrel as well as the handle, the cap, and/or all of the bat. Additionally, or alternatively, the second layer may be placed outside of the bat (e.g. a coating on the outside). The second layer may be formed from a single material or may be layered from different materials and/or have different materials in different areas (e.g. the handle and knob have one material while the barrel includes a different material). Further, while the first layer is depicted as a single layer of material, the first layer may be a double wall bat, such as a double wall composite bat, a triple wall bat, etc. First layer, as used in this application, should not be construed to require that the first layer is composed of a single layer of material. In many, or most, applications, first layer is a double wall composite, triple wall composite, or double wall metallic (usually aluminum or titanium) bat.

FIG. 1A illustrates an example bat in which the technologies and/or techniques described herein may be implemented. As shown in FIG. 1, bat 100 may include a handle 110, a barrel 120, and a cap 130. As shown in FIG. 1A, the handle 110 may include a first end and a second end opposite the first end, and a knob 111 may be located at the first end. The knob 111 may have a larger diameter than the rest of handle to prevent the user's hands from slipping off the bat 100 when the bat 100 is used. The handle 110 may be the portion of the bat 100 that is configured to be held by a user when the bat 100 is used to hit a ball or otherwise to play a softball and/or baseball game. A barrel 120 may extend from the handle 110 and may provide the portion of the bat 100 which is intended to strike a ball when the bat 100 is used in play. As shown in FIG. 1B, a portion of handle 110 may extend into barrel 120. The barrel 120 may have a larger diameter than the handle 110, which may provide additional surface area with which to contact a ball. A cap 130 may be connected to the barrel 120 opposite the handle 110 and may provide a closed end to the bat 100 opposite handle 110. In other embodiments, the material that forms barrel 130 may form cap 130 and/or may overlap cap 130. Handle may have a first end associated with the knob 111 and a second end associated with the barrel 120 (even though a portion of handle may extend into barrel, such as for two-piece bats). The components illustrated in FIG. 1A are provided for explanatory purposes only and the technologies and/or techniques described herein are not limited to the bat 100 or the components provided in FIG. 1A. There may be additional components, fewer components, different components or differently arranged components than illustrated in FIG. 1A. Also, in some implementations, one or more of the components of FIG. 1A may perform one or more functions described as being performed by another one or more of the components in FIG. 1A.

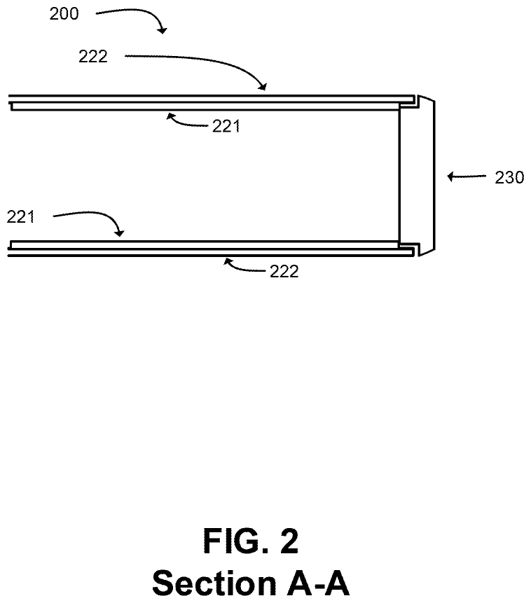

As shown in FIG. 1B, barrel 120 may include a first layer 121 and a second layer 122 disposed inside of the first layer 121 (as shown) and/or outside of the first layer 121 (as shown in FIG. 2). The first layer 121 may be the portion of bat 100 (e.g., aluminum, titanium, composite, single wall, double wall, etc.) that provides the “hot” surface of the barrel 120, which provides the most energy transfer (of the two layers) to a ball when the ball is hit by a player. The first layer 121 may be made from a variety of conventional bat barrels, including single wall, double wall and triple wall varieties. For example, first layer 121 may be formed from a single wall aluminum barrel, a single wall titanium barrel, a double wall aluminum barrel, a double wall titanium barrel, a single wall composite, a multi wall composite (2 walls, 3 walls, 4 walls, etc.) or any other conventional non-wooden barrel material, all of which are configured to provide a trampoline effect when hit by a ball. First layer 121 includes the components of the barrel of a typical bat, including paints, labels, etc., depicted as paint 121p (understanding that paints, labels, etc. may be applied to second layer 122, but may not be the sole component of second layer).

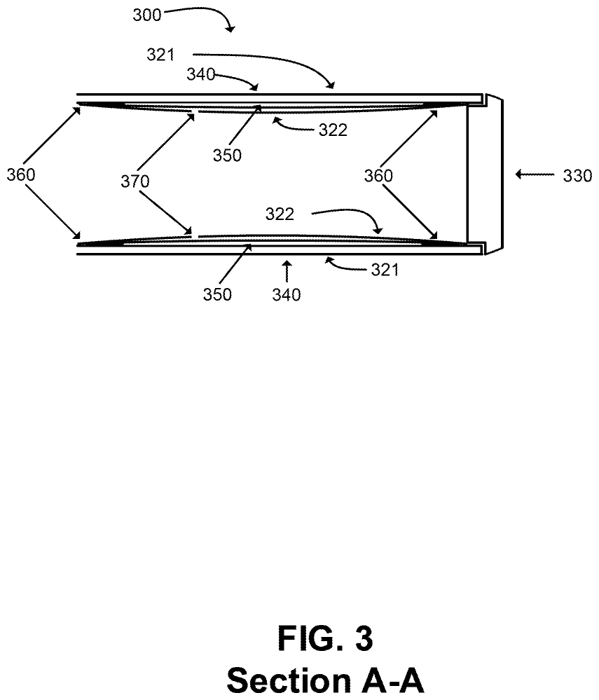

The second layer 122 may be disposed inside of first layer 121 or outside of the first layer 121 (as shown in FIG. 2), and may limit first layer 121 ability to deform when a ball is struck, prevent first layer 121 from fatiguing and/or prevent first layer 121 from cracking or otherwise deforming as a result of an impact with a ball. In some embodiments, second layer 122 is ideally disposed inside first layer 121 in order for the ball to make contact with first layer 121, which has the trampoline effect and therefore provides the “hotness” of the bat. Generally, second layer 122 is not as “hot” as first layer 121 and reduces the trampoline effect of first layer 121. Second layer 122 is not a paint or label that is traditionally applied to first layer, and is not a handle that is not a portion of handle that is placed within the barrel (such as in two-piece bats). Second layer 122 may be a layer adhered (some or all) to first layer 121 that provides rigidity and/or limits deformation of first layer 122 beyond the elastic deformation and/or beyond applicable hotness limits, while first layer 121 is the layer that provides the trampoline effect, or hotness, of the bat 100. Second layer 122 may prevent the first layer 121 from fatiguing or “breaking in” so that a bat 100 does not become “hotter” as a result of being used or as a result of other contact, which may prevent the bat from becoming illegal (i.e. as a result of exceeding “hotness” guidelines imposed by applicable league rules) for play. Additionally, or alternatively, a manufacturer may include second layer 122 to reduce the hotness of a bat 100 by lining a first layer 121 that, if used without second layer 122, would exceed hotness limitations. In this embodiment, second layer 122 may be added to the bat 100 to ensure that bat 100 complies with applicable guidelines. In one embodiment, second layer 122 may increase and/or decrease, such as by adding more material, until second layer 122 reaches a thickness that corresponds to bat 100 having the maximum, or very close to the maximum, hotness. Second layer 122 may also, or alternatively, be used on areas of the bat other than the barrel, such as the knob and/or handle, to increase durability, feel, etc. Second layer 122 may have a uniform thickness and/or (as shown in FIG. 3) may have a thickness that varies in the barrel, such as to most reduce the trampoline effect of the sweet spot while providing less support and/or reduction along other areas of the bat, which may increase the size of the sweet spot. Second layer 122 may be machined, worked, etc. when applied and/or after application to achieve the ideal thickness of second layer 122. General thickness of second layer 122 ranges dramatically depending on the materials used, the trampoline effect of first layer, etc., but may generally range from about 0.010 inches to about 0.5 inch in thickness.

Second layer 122 may be formed from any material that may limit and/or prevent deformation as described herein. Typically, second layer 122 is formed from a thermoplastic or a polyurea, like polypropylene, PET, polyethylenes, polyurethane, elastomeric polyureas (including spray on applications, etc.), two-part polymers, three-part polymers, etc. The thickness of the second layer 122 depends largely on the extent to which first layer 121 needs to be dampened and/or supported to limit permanent damage and/or exceeding applicable hotness rules. There are many different processes for applying second layer 122. For example, second layer 122 may be formed inside of first layer 121 using, for instance, a rotational molding process in which the material that is used to form second layer 122 is melted/placed in a liquid or semi-liquid state and then placed inside of first layer 121. Then, bat 120 is rotated while second layer solidifies (dries, cures, etc.) so that second layer 122 is distributed inside of first layer 121. Persons of ordinary skill in art are aware that the manner in which bat 100 is rotated may help determine the thickness of second layer 122. For example, bat 100 may be rotated in way to provide a uniform, or nearly uniform, thickness of second layer. Additionally, or alternatively, bat 100 may be rotated in a way to provide thicker and thinner areas of second layer 122 along first layer 121, such as shown in FIG. 3. Alternatively, second layer 122 may be formed by a blow molding process in which a sleeve that is used to form second layer is placed inside of first layer, heated, and then a pressure is applied such that second layer conforms to the shape of first layer 121 and adheres to first layer 121. The pressure may be applied by air pressure applied to the inside of the sleeve, when the sleeve is placed inside of the first layer 121, which causes the heated sleeve to expand and conform to the first layer 121, forming second layer 122. In this alternative, the thickness of the sleeve of material may determine the thickness of second layer 122, so that second layer 122 may have a uniform thickness, may have a tapered thickness (i.e. as shown in FIG. 3) or any other thickness to suit a particular application.

In other applications, second layer 122 may be formed in a spray on application. In such applications, the thickness of second layer 122 may be easily controlled by spraying the amount of material needed to achieve the desired thickness or thickness profile. May spray-on applications of second layer 122 exist. For instance, an elastomeric polyurea may be sprayed on first layer 121 in order to form second layer 122. In other embodiments, a powder coat spray may be applied to first layer 121 to create second layer 122 and may be heated/cured as is known in the art. When power coats are applied to composite first layers 121, the materials (i.e. resins, epoxies, etc.) used in first layer 121 must be carefully chosen to ensure that they can withstand the temperature requirements of curing process for powder coating, as well as other processes involving heat, such as blow molding, rotomolding, etc. Many of the materials used in composite bats presently sold will not withstand such temperatures, while the materials used in, for instance, aircraft composites, will withstand the temperatures needed to apply a powder coat.

A manufacturer may determine the thickness of second layer 122 based upon the hotness of first layer 121. If the first layer 121 is too hot, the manufacturer may include a second layer 122 that has a first thickness. If a first layer 121 is just above or right at the maximum hotness regulation, the manufacturer may use a second layer 122 having a second thickness that is thinner than the first thickness. Additionally, or alternatively, the thickness of the second layer 122 may correspond to a thickness required to prevent first layer 121 from deforming, or to limit the amount that first layer 121 deforms such that the deformation remains in the elastic region of deformity (i.e. there is no permanent deformation and/or deformation that would result in fractures or other permanent damage to first layer 121). For instance, in composite first layers 121, the thickness of second layer 122 may correspond to the thickness needed to limit and/or prevent microfractures, which initially increase trampoline effect but eventually cause failure. Additionally, a manufacturer may include second layer 122 that has a first layer 121 thickness and may then decrease the thickness of second layer 122 such as by machining, etc. until the point that the bat 100 reaches the maximum hotness allowed by applicable regulations. For example, after second layer 122 is placed inside of first layer, a boring bit, or some other boring mechanism, may bore out second layer 122 by removing material of second layer 122 until the boring bit may pass through second layer 122 (i.e. leaving a hollow channel inside of second layer having an inner diameter the size of the outer diameter of the boring bit). In another embodiment, when second layer 122 is disposed outside first layer 121, second layer 122 may be sanded to the proper thickness and/or bat 100 may be placed in a lathe, and second layer 122 may worked to the proper thickness by a tool bit (or sand paper, etc.).

In FIG. 1B, second layer 122 is shown as extending for the entire depicted region of barrel 120, but second layer 122 may be disposed only (or be thickest in) in some limited portion of the barrel 120 (i.e. the sweet spot or some other limited zone), which may allow other areas of the barrel to be as “hot” as the sweet spot (i.e. increasing the size of the sweet spot). Also, the second layer 122 may also be included in the handle 110, the knob 111 and may also underline the cap 130. Additionally, the second layer 122 may be used to attach the cap 130 to the barrel 120 such as when the second layer 122 is heated to the melting point and contacts the cap 130 and then dries to form a seal between the barrel 120 and the cap 130.

FIG. 2 depicts an alternative embodiment of bat 100 in which bat 100 includes barrel 200, which is similar to barrel 120 except that second layer 222 is located outside of first layer 221. Second layer 222 may be formed as discussed herein, and may limit and/or prevent first layer 221 from being too hot (i.e. from “breaking in” and/or by being too hot without second layer 222) and/or from being damaged/destroyed through normal use. When second layer 222 is disposed outside of first layer 221, as shown, additional characteristics of second layer 222 may be important. For instance, second layer 222 may be formed from a clear material so that first layer 221 (and/or any paint, labels, etc. applied to first layer) may be seen through second layer 222 (though second layer 122 may be formed from a clear material when second layer 122 is located inside of first layer 121, as depicted in FIG. 1B). In the configuration depicted in FIG. 2, second layer 222 may need to elastically deform in order to ensure that first layer 221 is able to deform to produce a spring-like, or trampoline, effect. While second layer 222 (and second layer 122) is intended to limit the deflection/deformation of first layer 221 such that it does not fracture, plastically deform/become too hot, second layer 222, especially when outside of first layer 221, should elastically deform in order to allow first layer 221 to deform when striking a ball in order to produce a trampoline effect that does not break the rules but that does provide the maximum “hotness” allowed under current rules. This is because, in this embodiment, second layer 222 strikes the ball, rather than first layer 221 striking the ball (i.e. as in FIGS. 1B and 3). As a result, the materials used to form second layer 222 may need to be flexible/ductile/etc. to a degree to achieve the maximum trampoline effect allowed by applicable rules.

FIG. 3 illustrates yet another embodiment of bat 100 which, instead of barrel 120, includes barrel 300. Like barrel 120, barrel 300 has a second layer 322 located inside of first layer 321. Barrel 300 may be the same as, or similar to, barrel 120 except that second layer 322 may include a gap 350 between first layer 321 and second layer 322 at or near sweet spot 340. As depicted in FIG. 3, gap 350 may be an area between first layer 321 and second layer 322 such that first layer 321 is allowed to deform, such as when a ball is struck, up to a certain point until first layer 321 contacts second layer 322. In this embodiment, the trampoline effect of first layer 321 may not be significantly limited until about the point at which first layer 321 strikes second layer 322 when the ball is struck at or near the sweet spot 340. Persons having ordinary skill in the art understand that the sweet spot 340 of the barrel 300 corresponds to the part of barrel 300 having the most trampoline effect (i.e. the hottest portion of barrel 300). Providing gap 350 between first layer 321 and second layer 322 may maintain the trampoline effect of first layer 321 to be within the rules and/or to keep first layer from fatiguing/cracking/etc., but may provide support when first layer 321 deflects to the point of being too hot and/or beginning to plastically deform/crack/fatigue, etc. Providing gap 350 at or near hot spot may keep the bat within the rules while providing maximum hotness (while limiting and/or preventing failures). The size and position of gap 350 may be determined by the materials of first layer 321, the location of sweet spot 340, applicable rules, etc. Second layer 322 may connect to/be joined with first layer 321 at connection points 360. Connection points 360 may correspond to specific spots and/or circumferences at which second layer 322 is connected to first layer 321. Second layer 322 may include penetrations 370 (holes, apertures, etc.) which may air, etc. from becoming trapped in gap 350, which may otherwise limit and/or prevent deflection of first layer 321 by requiring compression of such air, etc. in gap when first layer 321 is deformed from hitting a ball.

The foregoing description provides illustration and description, but is not intended to be exhaustive or to limit the implementations to the precise form disclosed herein. Modifications and variations are possible in light of the above disclosure or may be acquired from practice of the disclosed embodiments. It will be apparent that the technologies and/or techniques described herein may be implemented in many different forms and in many different ways in addition to those specifically described with reference to FIGS. 1A-3. The actual components and/or materials used to implement the embodiments reflected in FIGS. 1A-3 are merely example materials. It should be understood that the components and/or materials may be designed in any form or fashion to meet the requirements of a particular embodiment.

It should be emphasized that the terms comprises/comprising when used in this specification are taken to specify the presence of stated features, integers, steps or components, but does not preclude the presence or addition of one or more other features, integers, steps, components or other groups thereof.

What is claimed is:

1. A bat comprising:
a handle configured to be held by a user, the handle having a first end and a second end opposite the first end, the first end including a knob having a larger diameter than the handle; and
a barrel extending from the second end of a handle, the barrel configured to strike a ball during play, the barrel having
a first layer primarily composed of a single wall aluminum, a double wall aluminum, a single wall titanium, a double wall titanium, a single wall composite, a multi wall composite, and
a second layer connected to the first layer and configured to support the first layer to prevent the first layer from fatiguing, permanent damage, or exceeding applicable piles limiting the hotness of the bat.

2. The bat of claim 1 further comprising a gap between the first layer and the second layer.

3. The bat of claim 1, where the second layer includes an elastomeric polyurea.

4. The bat of claim 1, where the second layer includes a thermoplastic.

5. The bat of claim 1, where the first layer is outside of the second layer.

6. The bat of claim 1, where the first layer is inside of the second layer.

7. The bat of claim 1, where the first layer includes paint.

8. The bat of claim 2, where the gap is located at or near a sweet spot.

9. The bat of claim 1, where the second layer further includes an aperture.

10. The bat of claim 1, where the second layer has a uniform thickness.

11. The bat of claim 1, where the second layer has a non-uniform thickness.

12. The bat of claim 6, where the second layer is formed from a clear material.

13. The bat of claim 1 further including a cap connected to the barrel opposite the handle, the cap providing a closed end of the barrel.

14. The bat of claim 1, where the first layer is connected to the second layer at connection points.

15. A bat comprising:
a handle configured to be held by a user, the handle having a first end and a second end opposite the first end, the first end including a knob having a larger diameter than the handle; and
a barrel extending from the second end of a handle, the barrel configured to strike a ball during play, the barrel having
a first layer corresponding to the barrel of a conventional bat that is configured to provide a trampoline effect, and
a second layer connected to the first layer and configured to support the first layer to prevent the first layer from fatiguing, permanent damage, or exceeding applicable rules limiting the hotness of the bat.

16. The bat of claim 15, where the second layer includes an elastomeric polyurea.

17. The bat of claim 15, where the second layer includes a thermoplastic.

18. The bat of claim 15, where the first layer is formed from composite.

19. The bat of claim 15, where the first layer is formed from aluminum.

20. The bat of claim 19, where the first layer is formed from a double wall aluminum.

21. The bat of claim 15, where the first layer includes paint.
